(19) United States
(12) Patent Application Publication
(10) Pub. No.: US 2002/0065783 A1
(43) Pub. Date: May 30, 2002

(54) Method and system for providing and using ticket

(76) Inventors: Chung-seob Na, Suwon-city (KR); You-hyun Lee, Seongnam-city (KR); Seong-jin Ahn, Seoul (KR)

Correspondence Address: SUGHRUE, MION, ZINN,, MACPEAK & SEAS, PLLC, 2100 PENNSYLVANIA AVENUE, N.W., WASHINGTON, DC, 20037-3213, US

(21) Appl. No.: 09/808,030

(22) Filed: Mar. 15, 2001

(30) Foreign Application Priority Data
Nov. 29, 2000 (KR) 00-71716

(51) Int. Cl. G06F 17/60

(52) U.S. Cl. 705/64

(57) ABSTRACT

A method and system for providing a ticket to a user using a portable terminal and using the provided ticket are provided. The method for providing a ticket involves a server capable of issuing the ticket and a ticket issuer issuing the ticket requested to be issued by the portable terminal using wired or wireless communication in the form of an e-ticket and storing information related to the ticket issued in the terminal. The method for using a ticket involves a ticket authentication/entry processor requesting the ticket server that issues the ticket an inquiry for the ticket related information upon receipt of the ticket related information using wired or wireless communication and determining whether the user of the terminal is allowed an entry depending on the inquiry result. Accordingly, the loss of tickets for accessing events or facilities can be prevented, and resources can be saved since digital transactions eliminate a need to use tickets in a printed form.

### BACKGROUND OF THE INVENTION

1. Field of the Invention

The present invention relates to a method and system for providing a ticket to a user and using the provided ticket. The present application is based on Korean Patent Application No. 00-71716. filed Nov. 29, 2000, which is incorporated herein by reference.

2. Description of the Related Art

To access venues for events such as movies, plays, public performances, and sporting events, and to use facilities such as hotels, airlines, railways, buses, amusement parks, users must purchase tickets. A user may directly purchase a ticket at a related event or purchase the ticket in advance using communication means. When purchasing a ticket in this way, the user must receive a ticket in a printed form at a ticket window. The ticket window may be a ticket office, a member store, or an automatic ticket issuer.

Once a ticket is provided to a user according to the above ticket issuing methods, the user must retain the ticket for surrender at a venue for a public performances the user desires to see or at a facility the user desires to use. If the user loses the issued ticket, he may be denied access to the venue for the public performance or to the desired facility. Furthermore, organizers of performances or managers of facilities need additional employees who issue and examine tickets.

### SUMMARY OF THE INVENTION

To solve the above problems, it is an objective of the present invention to provide method and system for providing tickets to users using a portable terminal and using the provided thickets.

Accordingly, to achieve the above objectives, the present invention provides a method of providing a ticket using a portable terminal and a server that is capable of issuing tickets. The method includes receiving a request for issuance of a predetermined ticket from the terminal, checking a communications protocol between the server and the terminal upon receipt of the request for ticket issuance, and converting information related to the ticket requested to be issued according to the corresponding communications protocol and transmitting the converted result to the terminal. Preferably, the method further includes storing the ticket related information in the terminal.

The present invention also provides a method for providing a ticket to a portable terminal through a ticket issuer. The method includes receiving a request for issuance of a ticket from the terminal, the ticket issuer requesting a server that is capable of issuing the ticket for information related to the ticket upon receipt of the request for ticket issuance, receiving the ticket related information from the server, checking a communications protocol between the ticket issuer and the terminal upon receipt of the ticket related information, and converting the ticket related information according to the corresponding communications protocol and transmitting the converted result to the terminal.

The present invention also provides a method for using a ticket received using a portable terminal. The method includes receiving information related to the ticket from the terminal, analyzing the ticket related information and determining a server that issues the ticket upon receipt of the ticket related information, requesting the server for an inquiry for the ticket related information, receiving the inquiry request result from the server, and determining whether the user of the terminal is allowed entry depending on the received inquiry result.

The present invention also provides a system for providing a ticket. The system includes a portable terminal for storing information related to a ticket issued, a database for storing information related to one or more tickets, and a server including a storage unit and a processor connected to the storage unit, wherein the storage unit stores a program for controlling the processor and the processor executes the program to retrieve information related to the ticket from the database when a request for issuance of the ticket is made by the terminal, to check a communication protocol with the terminal, and to convert the retrieved ticket related information according to the corresponding communications protocol and transmit the result to the terminal.

### BRIEF DESCRIPTION OF THE DRAWINGS

The above objectives and advantages of the present invention will become more apparent by describing in detail preferred embodiments thereof with reference to the attached drawings in which:

FIG. 1 is a functional block diagram of a system for providing and using tickets according to the present invention;

FIG. 2 shows the format of ticket data according to the present invention;

FIG. 3 is a flowchart of the operation of the ticket server in a method for providing tickets according to the present invention;

FIG. 4 is a flowchart of the operation of the ticket issuer in a method for providing tickets according to the present invention;

FIG. 5 is a flowchart of the operation of the terminal in a method for providing tickets according to the present invention;

FIG. 6 is a flowchart of the operation of the ticket authentication/entry processor in a method for using tickets according to the present invention; and

FIG. 7 is a flowchart of the operation of the ticket server in a method for using ticket.

### DETAILED DESCRIPTION OF THE INVENTION

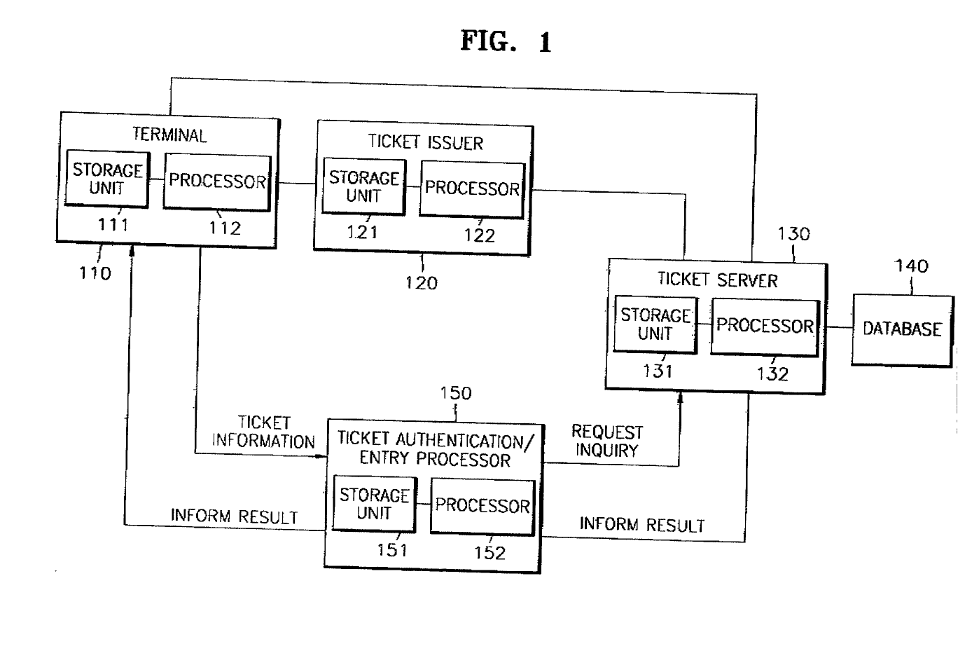

FIG. 1 is a functional block diagram of a system for providing and using tickets according to the present invention applied both when using and not using a ticket issuer. Referring to FIG. 1, the system for providing and using tickets includes a terminal 110, a ticket issuer 120, a ticket server 130, a database 140, and a ticket authentication/entry processor 150. The terminal 110 is a portable terminal such as a cellular phone, a personal digital assistant (PDA), a handheld PC (HPC), and a notebook PC. The terminal 110 is constructed so as to store information related to tickets issued. For this purpose, the terminal 110 includes a storage unit 111 and a processor 112 connected to the storage unit 111. The storage unit 111 may store a program for controlling the operation of the processor 112 and information related to tickets issued.

The processor 112 operates so as to store information related to tickets issued in the storage unit 111. When using tickets, the processor 112 delivers the information related to tickets issued from the storage unit 111 to the ticket authentication/entry processor 150. The terminal 110 may be connected to the ticket issuer 120, the ticket server 130, and the ticket authentication/entry processor 150 through a wired or wireless network.

The ticket issuer 120 issues a ticket requested to be issued by the terminal 110. In this case, the ticket issued is provided in a form suitable for a communications protocol between the terminal 110 and the ticket issuer 120. The ticket issued may be expressed as an e-ticket.

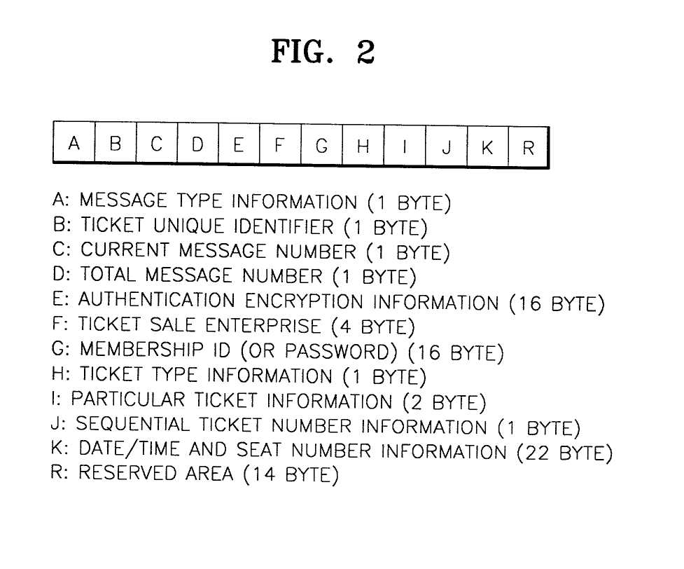

Data of the ticket issued may be constructed as shown in FIG. 2. That is, data of the ticket issued includes one-byte message type information A; 1-byte ticket unique identifier information B; 1-byte current message number information C; 1-byte total message number information D; 16-byte authentication encryption information E; 4-byte ticket sale place information F; 16-byte membership ID (or password) information G; 1-byte ticket type information H; 2-byte particular ticket information I; 1 -byte sequential ticket number information J; 22-byte date/time and seat number information K; and a 14-byte reserved area R. Areas allocated for each information may be modified depending on management conditions. The information in the areas F-K relates to details of the ticket issued.

The ticket issuer 120 includes a storage unit 121 and a processor 122 connected to the storage unit 121. A program for controlling the processor 122 is stored in the storage unit 121. When a ticket is requested to be issued by the terminal 111, the processor 122 requests the ticket server 130 that is capable of issuing tickets to send information related to the requested ticket. When the information related to the ticket is provided from the ticket server 130, the ticket issuer 120 checks a communications protocol with the terminal 110. The communications protocol considers both a wide area protocol using a Short Message Service (SMS) and a local area protocol using a bluetooth, an Infrared Data Association IRDA, a radio frequency (RF), and a serial method directly connecting a cable. The information related to the ticket is converted into a form that complies to a corresponding communications protocol and sent to the terminal 110.

The ticket server 130 may provide information related to the ticket which the terminal 110 requests to be issued directly to the terminal 110 or through the ticket issuer 120. Also, when using the ticket, the ticket server 130 responds to an inquiry for data related to the ticket made by the ticket authentication/entry processor 150. To this end, the ticket server 130 includes a storage unit 131 and a processor 132 connected to the storage unit 131. A program for controlling the processor 132 is stored in the storage unit 131.

If the terminal 110 directly requests for the ticket to be issued, the processor 132 retrieves information related to the requested ticket from the database 140. Then, the processor 132 checks a communications protocol between the terminal 110 and the ticket server 130. The check is made in the same manner as in the ticket issuer 120. If the communications protocol is checked, the processor 132 converts the ticket related information according to the checked communications protocol and sends the result to the terminal 110.

However, if information related to the ticket is requested through the ticket issuer 120, the processor 132 retrieves the information related to the ticket from the database 140 and sends the retrieved information related to the ticket to the ticket issuer 120. Also, if an inquiry for data related to the ticket is made by the ticket authentication/entry processor 150, the processor 132 makes a request for the ticket related data from the database 140 and sends the inquiry result to the ticket authentication/entry processor 150.

The ticket server 130 is allocated for each ticket sale enterprise. Thus, although only one ticket server 130 is shown in FIG. 1 for convenience of explanation, if the number of ticket sale enterprises is N, the ticket server 130 may be constructed as a group of ticket servers 130 including a number N of ticket servers. The database 140 stores information related to tickets to be issued and issued tickets. The information related to tickets to be issued refers to information created from advance purchases by users through a communication means such as a telephone service or the Internet.

Upon receipt of information related to a ticket from the terminal 110, the ticket authentication/entry processor 150 executes an authentication process for the ticket related information and processes an entry for the user of the terminal 110 so as to use the ticket. For this purpose, the ticket authentication/entry processor 150 includes a storage unit 151 and a processor 152 connected to the storage unit 151. The storage unit 151 stores a program for controlling the processor 152.

When the ticket-related information is received from the terminal 110, the processor 152 analyzes information about the ticket sale enterprise contained in the received ticket related information to find a ticket server associated with the ticket sale enterprise. If the determined ticket server is the ticket server 130, the processor 152 requests the ticket server 130 for an inquiry for the received ticket related information. Upon receipt of the inquiry result from the ticket server 130, the processor 152 determines whether or not the user of the terminal 110 is allowed an entry depending on the received inquiry result. In this case, the processor 152 may transmit the inquiry result to the terminal 110. The terminal 110 can send data to and receive data from the ticket authentication/entry processor 150 using wired or wireless communication.

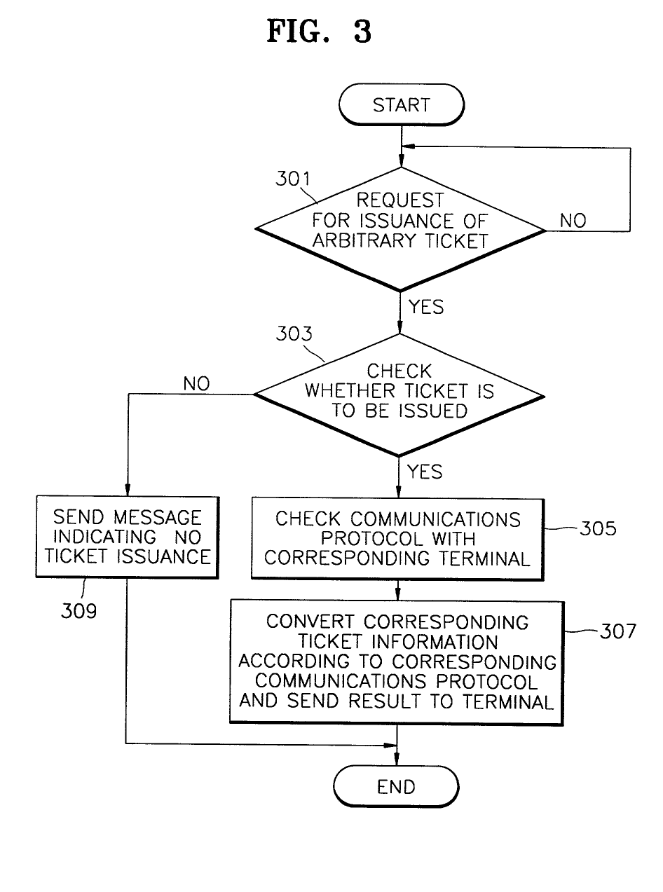

FIG. 3 is a flowchart of an operation of the ticket server 130 in a method for providing a ticket according to the present invention without using the ticket issuer 120. More specifically, if the terminal 110 requests an arbitrary ticket to be issued in step 301, the ticket server 130 checks whether or not the corresponding ticket is to be issued in step 303. The check is made by checking whether or not information related to the corresponding ticket exists in the database 140. That is, if the corresponding ticket related information exists in the database 140, the corresponding ticket is to be issued. Conversely, if the ticket related information does not exist in the database 140, the corresponding ticket cannot be issued.

If the corresponding ticket is issuable, the ticket server 130 checks a communications protocol with the terminal 110 in step 305. This check is made in the same manner as in FIG. 1. If the communications protocol is checked, information related to the ticket is converted into a form according to the corresponding communications protocol and sent to the terminal 110. On the other hand, if the corresponding ticket is not issuable, the ticket server 130 transmits a message indicating that the corresponding ticket cannot be issued to the terminal 110 in step 309.

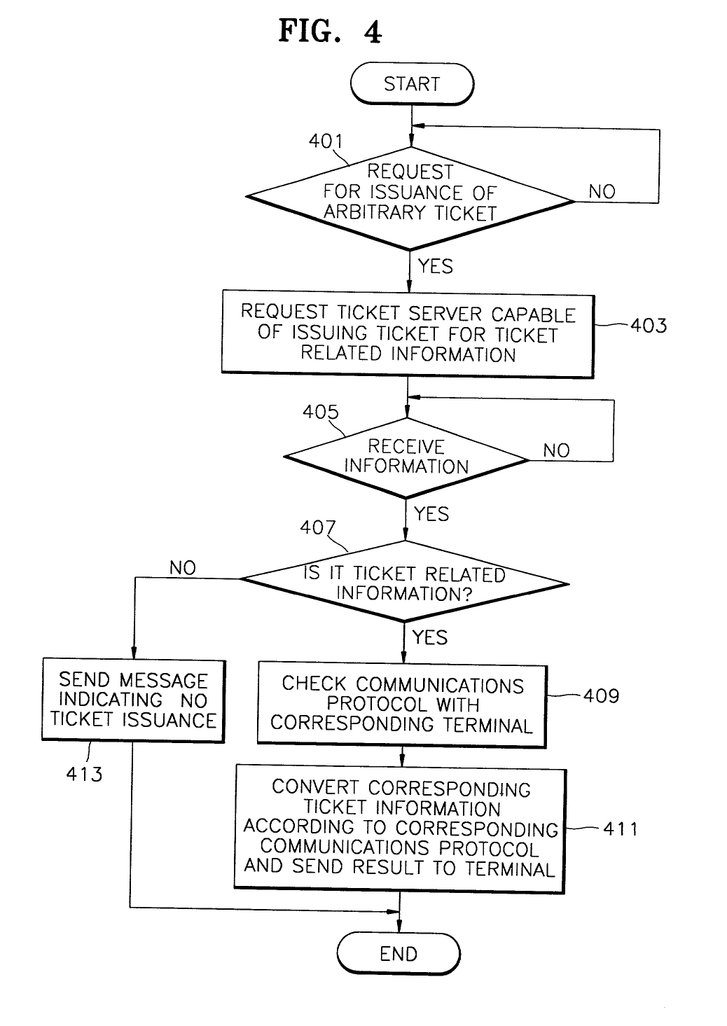

FIG. 4 is a flowchart of an operation of the ticket issuer 120 in a method for providing a ticket according to the present invention. More specifically, if the terminal 110 requests issuance of an arbitrary ticket in step 401, the ticket issuer 120 requests the ticket server 130, which is capable of issuing tickets, for information related to the corresponding ticket. In this case, the ticket issuer 120 determines the ticket server 130 associated with the ticket based on the request for ticket issuance received from the terminal 110.

In this case, upon receipt of the request for ticket related information from the ticket issuer 120, the ticket server 130 retrieves information related to the corresponding ticket from the database 140 and sends the retrieved result to the ticket issuer 120. If the ticket related information does not exist in the database 140, the ticket server 130 sends a corresponding message to the ticket issuer 120. Upon receipt of the information from the ticket server 130 in step 405, a check is made as to whether or not the received information is the ticket related information in step 407. If the received information is the ticket related information, a communications protocol between the terminal 110 and the ticket issuer 120 is checked in step 409. This check is made in the same manner as described with reference to FIG. 1. If the communications protocol is checked, information related to the corresponding ticket is converted according to the corresponding communications protocol and sent to the terminal 110. On the other hand, if the received information is not the ticket related information as a result of the check made in the step 407, a message indicating that the corresponding ticket cannot be issued is sent to the terminal 110.

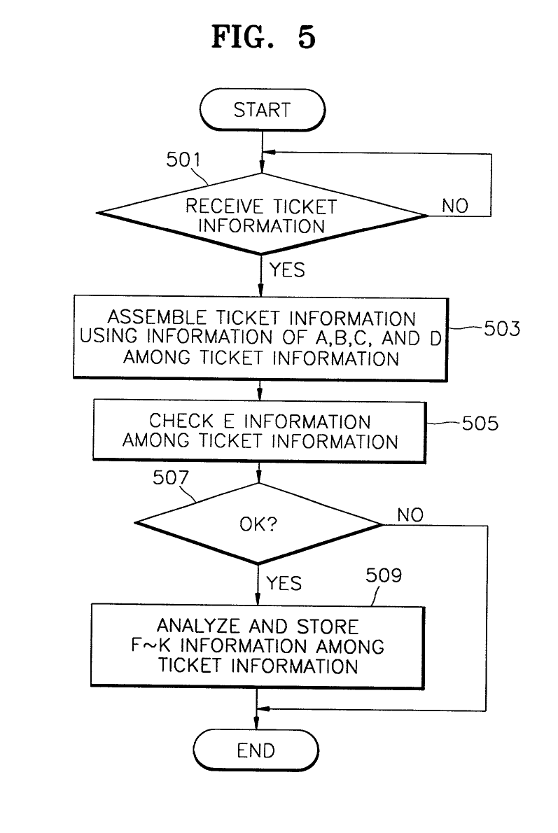

FIG. 5 is a flowchart of an operation of the terminal 110 in a method for providing a ticket according to the present invention. More specifically, if information related to a ticket which the terminal 110 requests to be issued is received in a format as shown in FIG. 2 in step 501, the terminal 110 analyzes the areas A, B, C, and D of information related to the corresponding ticket and assembles information related to the corresponding ticket using the analyzed result in step 503. For example, if there are a plurality of messages for information related to the corresponding ticket as a result of analyzing the information C and D, the received ticket related information is assembled using all the messages such that information related to one ticket is stored.

In step 505, E information of the ticket related information is analyzed to confirm the analyzed result to the user. That is, information of the area E is provided in order for the user to see. After checking the indicated E information, if the encrypted information for authentication is identical to what the user has been aware of, the user inputs “OK” information. If not, the user inputs “NOK” information. If the “OK” information is input, the F-K information among the received ticket related information is analyzed to store information related to the ticket in the terminal 110 based on the analyzed result. In this case, the received ticket related information may be classified and stored based on the result of analyzing the F-K information and a set classification criterion. The classification criterion may be the ticket sale enterprise, the type of a ticket, or the date on which the ticket is used. On the other hand, if the “OK” information is not input in the step 507, the received ticket related information is not stored in the terminal 110.

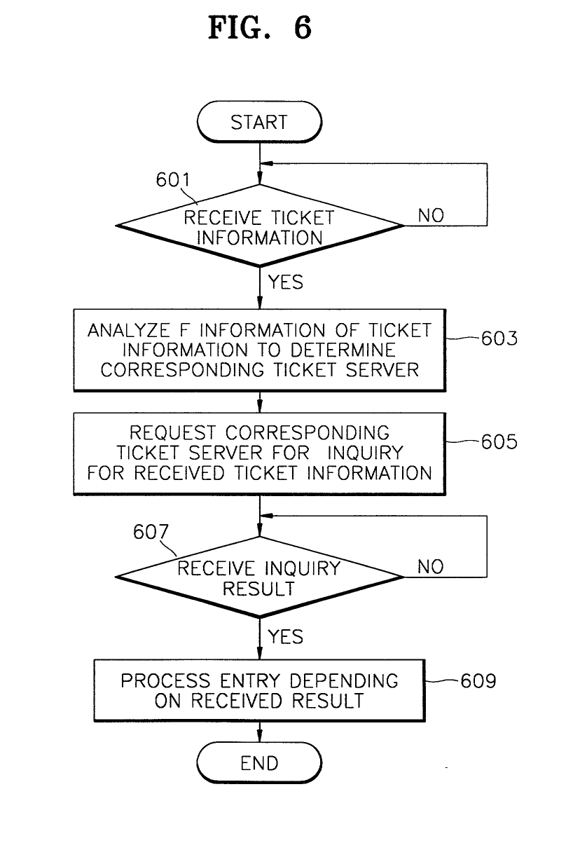

FIG. 6 is a flowchart of an operation of the ticket authentication/entry processor 150 in a method for using a ticket according to the present invention. More specifically, upon receipt of ticket related information from the terminal 110 in step 601, the ticket authentication/entry processor 150 analyzes F information of the ticket information to determine a corresponding ticket server in step 603. If the corresponding ticket server is the ticket server 130, the ticket authentication/entry processor 150 requests the ticket server 130 for an inquiry for the received ticket information in step 605. Upon receipt of the inquiry result from the ticket server 130 in step 607, the ticket authentication/entry processor 150 determines whether an entry is allowed. That is, if it is determined that the ticket related information is allowed an entry according to the received inquiry result, the ticket authentication/entry processor 150 processes such that the user of the terminal 110 is allowed an entry. On the other hand, if it is determined that the ticket information is denied an entry according to the received inquiry result, the ticket authentication/entry processor 150 processes such that the user of the terminal 110 is denied an entry. In this case, the ticket authentication/entry processor 150 may inform the terminal 110 of the received inquiry result.

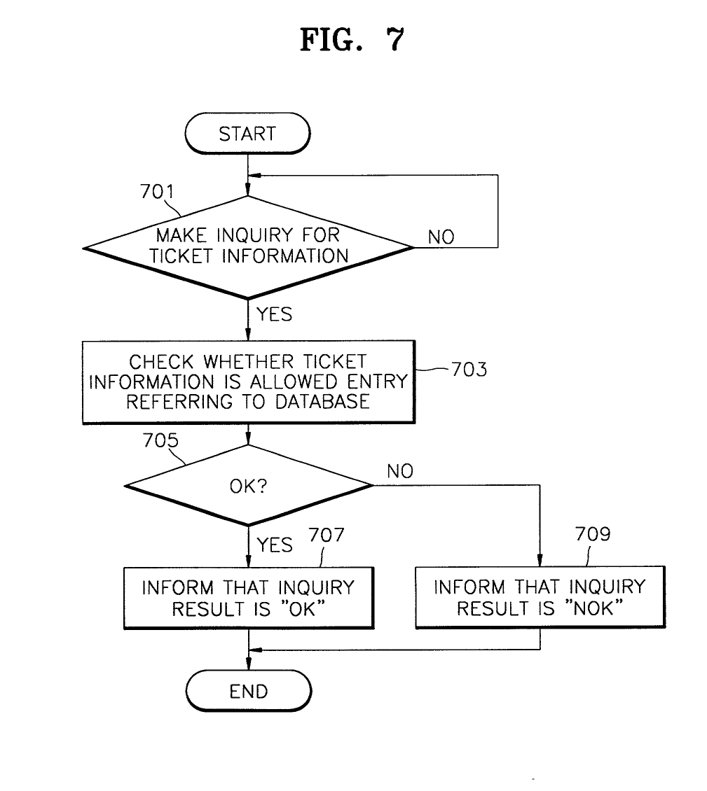

FIG. 7 is a flowchart of an operation of the ticket server 130 in a method for using a ticket according to the present invention. More specifically, if an inquiry for ticket related information is made by the ticket authentication/entry processor 150 in step 701, the ticket server 130 checks whether the ticket information is allowed an entry referring to the database 140 in step 703. If the ticket information is allowed an entry, the ticket server 130 informs the ticket authentication/entry processor 150 that the inquiry result is “OK”. On the other hand, if the ticket information is denied an entry, the ticket server 130 informs the ticket authentication/entry processor 150 that the inquiry result is “NOK”.

The present invention can prevent the loss of tickets for accessing events or facilities while allowing for digital transactions to eliminate a need to use a ticket in a printed form thereby saving resources. Furthermore, the present invention does not need employees for selling or examining tickets thereby reducing personnel expenses. Also, the terminal can serve a very wide range of uses.

What is claimed is:

1. A method of providing a ticket using a portable terminal and a server that is capable of issuing tickets, the method comprising:
receiving a request for issuance of a predetermined ticket from the terminal;
checking a communications protocol between the server and the terminal upon receipt of the request for ticket issuance; and
converting information related to the ticket requested to be issued according to the corresponding communications protocol and transmitting the converted result to the terminal.

2. The method of claim 1, wherein the request for ticket issuance and transmission of the ticket related information are made using wired or wireless communication.

3. The method of claim 1, wherein, in checking the communications protocol, the server considers both an wide area protocol and a local area protocol.

4. The method of claim 1, wherein, in transmitting the converted ticket related information to the terminal, the ticket related information includes message type information, ticket unique identifier information, encryption information for authentication, and ticket detail information.

5. The method of claim 4, wherein, in transmitting the converted ticket related information to the terminal, the ticket related information further includes information about current message number and a total message number.

6. The method of claim 4, wherein, in transmitting the converted ticket related information to the terminal, the ticket detail information includes information about a ticket sale enterprise, membership ID, type of ticket, particular ticket information, sequential ticket number, date and time when a ticket is used, and a seat number.

7. The method of claim 1, further comprising storing the ticket related information in the terminal.

8. The method of claim 7, wherein storing the ticket related information in the terminal comprises:
analyzing the ticket related information in the terminal; and
storing the ticket related information using a result of the analyzing step.

9. The method of claim 8, wherein, in storing the ticket related information using the result of the analyzing step, the ticket related information is classified and stored referring to the result of analyzing ticket detail information contained in the ticket related information in analyzing the ticket related information in the terminal and according to a predetermined standard.

10. The method of claim 9, wherein the predetermined standard is the ticket sale enterprise, type of ticket, or the date on which the ticket is used.

11. The method of claim 8, wherein storing the ticket related information using the result of the analyzing step further comprises assembling received ticket information referring to a result of analyzing message type information, ticket unique identifier information, and information about current message number and a total message number contained in the ticket related information in analyzing the ticket related information in the terminal.

12. The method of claim 8, wherein storing the ticket related information in the terminal further comprises:
confirming the result of analyzing the authentication encryption information for authentication contained in the ticket related information to the user of the terminal in analyzing the ticket related information in the terminal; and
returning to storing the ticket related information using the result of analyzing the ticket related information if a user instruction that the encryption information for authentication is correct is input.

13. The method of claim 1, further comprising checking whether the ticket can be issued for the terminal upon receipt of the request for ticket issuance and returning to checking the communications protocol between the server and the terminal if the corresponding ticket is issuable.

14. A method for providing a ticket to a portable terminal through a ticket issuer, the method comprising:
receiving a request for issuance of a ticket from the terminal;
the ticket issuer requesting a server that is capable of issuing the ticket for information related to the ticket upon receipt of the request for ticket issuance;
receiving the ticket related information from the server;
checking a communications protocol between the ticket issuer and the terminal upon receipt of the ticket related information;
converting the ticket related information according to the corresponding communications protocol and transmitting the converted result to the terminal.

15. A method for using a ticket received using a portable terminal, the method comprising:
receiving information related to the ticket from the terminal;
analyzing the ticket related information and determining a server that issues the ticket upon receipt of the ticket related information;
requesting the server for an inquiry for the ticket related information;
receiving the inquiry request result from the server; and
determining whether the user of the terminal is allowed an entry depending on the received inquiry result.

16. The method of claim 15, wherein, in analyzing the ticket related information and determining the server that issues the ticket upon receipt of the ticket related information, the server is determined by analyzing information about a ticket sale enterprise contained in the ticket related information.

17. The method of claim 15, wherein determining whether the user of the terminal is allowed an entry further comprises transmitting the inquiry result to the terminal.

18. A system for providing a ticket comprising:
a portable terminal for storing information related to a ticket issued;
a database for storing information related to one or more tickets; and
a server including a storage unit and a processor connected to the storage unit, wherein the storage unit stores a program for controlling the processor and the processor executes the program to retrieve information related to the ticket from the database when a request for issuance of the ticket is made by the terminal, to check a communication protocol with the terminal, and to convert the retrieved ticket related information according to the corresponding communications protocol and transmit the result to the terminal.

19. The system of claim 18, wherein the portable terminal is a terminal connected to the server through a wired or wireless network.

20. The system of claim 19, wherein the terminal is selected from the group including, a cellular phone, a personal digital assistant (PDA), a handheld PC (HPC), and a notebook personal computer (PC).

21. The system of claim 18, wherein, if the communication protocol is a wide area protocol using a Short Message Service (SMS), the server transmits the ticket related information conforming to a SMS standard, and if the communication protocol is one of a local area protocol, an Infrared Data Association (IrDA) standard, a wireless communication and a serial data transfer using a cable, the server transmits the ticket related information conforming to the corresponding local area protocol.

22. The system of claim 21, wherein the local area protocol is a bluetooth protocol.

23. The system of claim 21, wherein the wireless communication utilizes radio frequency (RF) signals.

24. The system of claim 18, wherein the terminal separates and stores the ticket related information based on the result of analyzing the ticket related information received from the server and a predetermined standard.
